(19) United States
(12) Patent Application Publication
(10) Pub. No.: US 2016/0201365 A1
(43) Pub. Date: Jul. 14, 2016

(54) CABINET DOOR AND DRAWER RETAINING DEVICE AND METHOD FOR SECURING CABINET DOORS AND DRAWERS

(71) Applicant: Matthew James Carreras, Wailua, HI (US)

(72) Inventor: Matthew James Carreras, Wailua, HI (US)

(21) Appl. No.: 14/991,475

(22) Filed: Jan. 8, 2016

Related U.S. Application Data
(60) Provisional application No. 62/101,340, filed on Jan. 8, 2015.

(51) Int. Cl. E05C 19/18; E05B 65/46; E05C 19/00

(52) U.S. Cl. CPC E05C 19/188; E05C 19/003; E05B 65/467

(57) ABSTRACT

A tension rod assembly that secures doors and drawers of cabinets and chests and the contents thereof from young very small children without altering the cabinet or chest and without the need for hardware or tools. The assembly fits between the underside of countertops lips and the floor, and is held in place by a tensioning means. The assembly may be made length adjustable to accommodate cabinets and chests of different heights and to provide more or less tensioning force. Non-skid surface material can be applied to the top and bottom of the assembly to increase its effectiveness.

### CROSS-REFERENCE RELATED TO RELATED APPLICATION

This application claims the benefit of U.S. provisional patent application Ser. No. 62/101,340 filed on Jan. 8, 2015 in the name of the present inventor, which provisional application is incorporated in its entirety by this reference.

### FIELD OF THE INVENTION

The present invention relates to an apparatus and method for securing cabinet and chest drawers and doors. More specifically, the subject invention describes a device which is secured to the underside lip of cabinet and chest countertops to deter young children such as infants or toddlers from gaining access into cabinet drawers and/or doors, and a method of using the same.

### BACKGROUND OF THE INVENTION

The prior art discloses a wide variety of cabinet locks and child safety locks to deter young children from accessing the contents of low level cabinets and drawers. However, the available prior art child locks require alteration to the cabinet doors, doorknobs or drawers, which makes their use difficult or inconvenient, damages the cabinets, or makes them less appealing. For example, the Scottino patent, U.S. Pat. No. 6,352,290 B 1, requires modified cabinet doorknobs. The Hendriks patent, U.S. Pat. No. 4,629,263, requires a pair of support members that must be secured to the cabinets such as by bolts or by welding. The McLarnon patent, U.S. Pat. No. 3,805,565, discloses a locking mechanism consisting of a lock housing and one or more flat-bottomed slots in the housing to receive a flange from an article to be secured to the housing and a key-operated locking shaft. The Holden patent, U.S. Pat. No. 1,695,896, describes a drawer fastener which is permanently secured to a wardrobe trunk and allows for the easy locking of different drawers while not being in the way when not in use. The Stockov patent, U.S. Pat. No. 1,613,732, utilizes a lock at an end drawer with a key-operated bolt which affixes said drawer in a closed position alongside the trunk wall and a locking rod affixed to the trunk wall and running transversely of the drawers.

The present invention solves the problem identified by providing a device that uses tension and friction to secure cabinet doors and drawers. The present invention does not require alteration to the kitchen or bathroom cabinet door, doorknobs, or drawers. The device of the subject invention can be used with any cabinet that has a countertop that overhangs or extends beyond the cabinet front surface, and does not require doorknobs or special hardware. The subject invention requires very little skill and no tools to install and is portable for temporary use.

The foregoing and other objects, features and advantages of the invention will be apparent from the following more particular description of a preferred embodiment of the invention, as illustrated in the accompanying drawings wherein like reference numbers represent like parts of the invention.

### SUMMARY OF THE INVENTION

The cabinet and chest door and drawer retaining device of the subject invention comprises a spring-loaded tension rod assembly that is secured to the underside of a cabinet's countertop and that deters access to the cabinet's drawers and doors by young children. When in place, the device extends between the underside of the countertop and the floor. The tension created by the tension rod pressing upward against the underside of the countertop and downward against the floor is sufficient to secure the device in place and to deter young children from removing the device to access the contents of the cabinet.

To use the device, the assembly is compressed by depressing the top, slid into place so that the top of the device engages against the underside lip of the countertop, and then released. To remove the device, the assembly is again compressed, removed from the underside lip of the countertop, and again released.

According to one embodiment, the device has a vertically adjustable foot to adopt the device for use with cabinets of different heights, and/or to increase or decrease the resting tension of the rod assembly when in place securing a cabinet.

According to another embodiment, a non-skid surface is applied to the top and/or bottom surface of the device to make moving the secured assembly without depressing and compressing the assembly more difficult.

One aspect of the instant invention is a tension rod assembly that can be used with cabinets and chests having tabletops that extend beyond the front surface of the cabinet to secure the cabinet and its contents from being accessed by young children.

A second aspect of the instant invention is a device that deters young children from accessing the contents of cabinets and cabinet draws that does not require any alteration of the cabinets or cabinet components.

A third aspect of the instant invention is a device that deters young children from accessing the contents of cabinets and draws that does not require any tools or special hardware to install or to use.

A fourth aspect of the instant invention is a device that deters young children from accessing the contents of cabinets and drawers that has an adjustable foot to accommodate cabinets of different heights and/or to vary the resting tension of the assembly when the device is in place securing the cabinet.

A fifth aspect of the instant invention is a device that prevents young children from accessing the contents of cabinets and drawers that is portable for temporary use.

Further aspects of the subject invention are the method of using the device and a system that includes both the device and cabinets or chests that have lips that extend from the front thereof.

These and further aspects and other objects and features of the invention are apparent in the disclosure, which includes the above and ongoing written specification, drawings and claims.

### BRIEF DESCRIPTION OF DRAWINGS

FIG. 1 is a perspective view of the cabinet door and drawer retaining device.

FIG. 2 is a perspective view of the invention in use securing the contents of a sink cabinet from access by young children.

FIG. 3 is a preferred embodiment of the cabinet door and drawer retaining device in an exploded view, showing its component parts.

### DETAILED DESCRIPTION OF PREFERRED EMBODIMENTS

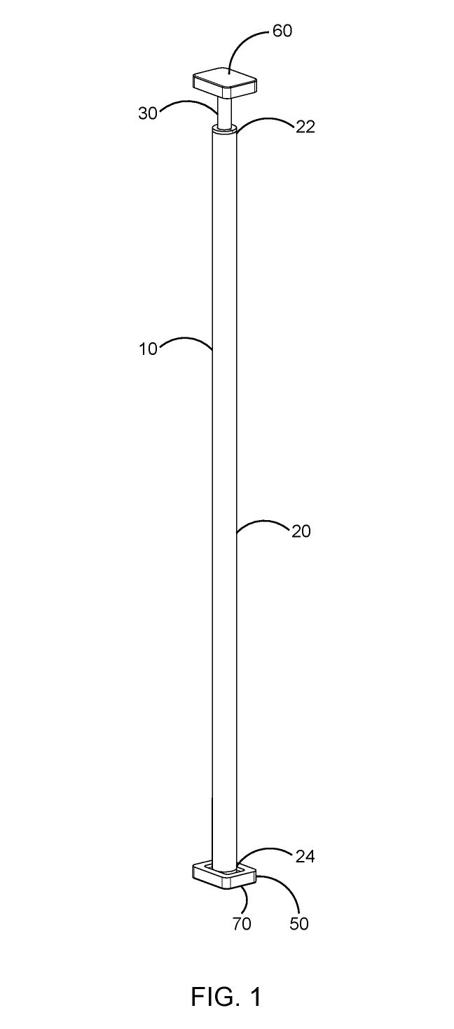

Depicted in FIG. 1 is a preferred embodiment 10 of the cabinet door and drawer retaining device of the present invention in perspective view. A hollow pole 20 has a top end 22 and a bottom end 24. Partially inserted into top end 22 of pole 20 is tensioner assembly 30. Tensioner assembly 30 has a top surface 60, located on the end of tensioner assembly 30 away from pole 20. Attached to bottom end 24 of pole 20 is a foot 50, which has a bottom surface 70 located on the end of foot 50 away from pole 20. Top surface 60 and bottom surface 70 are parallel to one another and perpendicular to pole 20.

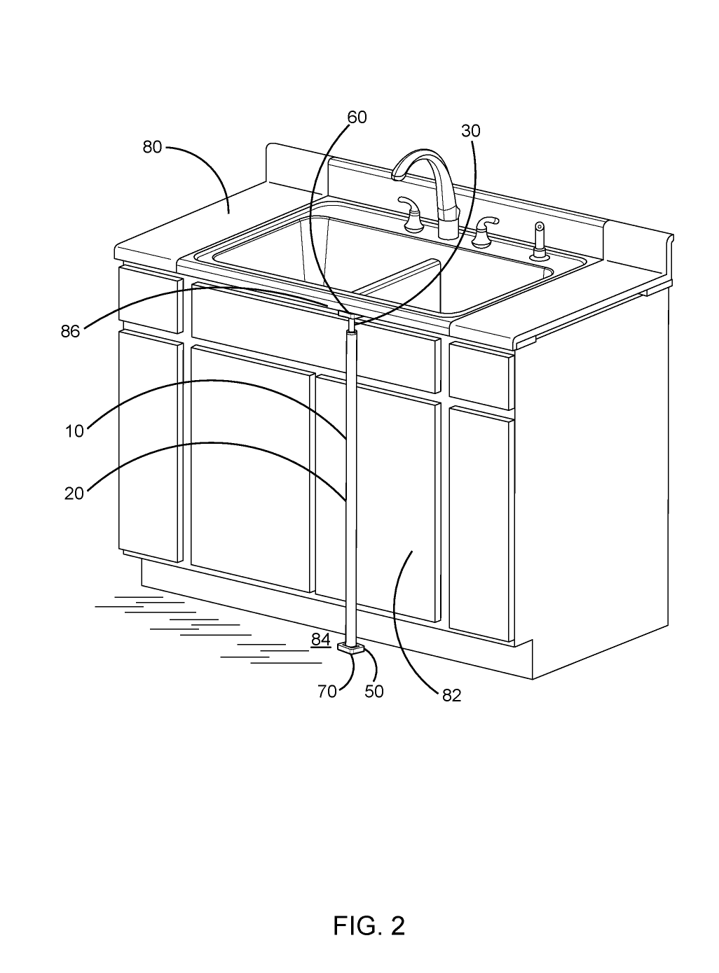

FIG. 2 illustrates a perspective view of cabinet door and drawer retaining device 10 used to secure a door of a sink cabinet. Device 10 is inserted between the floor 84 and the underside of a countertop lip 86 of a sink kitchen cabinet 80. FIG. 2 depicts a cabinet with two doors, one of which, a door 82, is being secured by device 10. Depending on the configuration of the doors on the cabinet, one device 10 may be used to block two adjacent doors by placing device 10 between the underside of a counter top lip 38 and floor in front of the two doors such that the swing path of both doors is blocked by device 10. Otherwise, two device 10s could be used to secure both doors of the cabinet.

As illustrated in FIG. 2, when device 10 is in use, top surface 60 of tensioner assembly 30 presses upwards against the underside of lip 86 while bottom surface 70 of foot 50 presses downward on floor 84. Pole 20 is perpendicular to floor 84 and parallel with front surface of cabinet 80. Pole 20 deters door 82 from opening by blocking the swing path of door 82.

In its state of rest, the length between top surface 60 and bottom surface 70 of device 10 will be slightly longer than the distance between floor 84 and underside of counter top lip 86 of cabinet 80. Thus, pole 20 can vary in length to fit cabinets of different heights, including, but not limited to, kitchen countertops which are typically 36 inches above the floor, or bathroom countertops which are typically 32 inches above the floor.

To install the subject invention, the user first places bottom surface 70 on floor 84 at the base of cabinet 80 in front of the drawers or doors to be secured and directly below countertop lip 86. The user next applies a downward force perpendicular to top surface 60, which engages tensioner assembly 30 and decreases the length between top surface 60 and bottom surface 70 to less than the distance between floor 84 and underside of countertop lip 86. While the device 10 is in a compressed state, the user slides top surface 60 under countertop lip 86 so that pole 20 is entirely vertical and flush against the cabinet drawer or door, and then releases top surface 60 to allow assembly 30 to expand and press upwards against the underside of lip 86.

When the subject invention is in a compressed state, tensioner assembly 30 is engaged and produces a tension force in the outward direction as it tries to return device 10 to its uncompressed state of rest. The tension created by tensioner assembly 30 is sufficient to keep device 10 standing upright between floor 84 and countertop 86 and prevents device 10 from being removed, in a sliding fashion, from the underside of lip 86. As such, a young child, such as an infant or toddler, is unable to open door 82 or pull pole 20 away from door 82.

While cabinet 80 is shown in FIG. 2 as a kitchen sink cabinet, the restrained cabinet can be all variety of chests or cabinets, those that have doors and those that have drawers, and chest or cabinets used in all aspects of a home or a business.

Although the standard height of a kitchen countertop is typically 36 inches and the standard height of a bathroom countertop is typically 32 inches above the floor, there are often slight variations in height due to factors such as uneven floor leveling. To accommodate for such variations, foot 50 can be adjustable to increase or decrease the length between top surface 60 and bottom surface 70. Such an increase or decrease in length will increase or decrease the tension produced by tensioner assembly 30.

Either or both top surface 60 and bottom surface 70 can be treated or covered with a non-skid coating, such as rubber or silicone, which increases the friction between, for example, top surface 60 and underside of countertop lip 86, and bottom surface 70 and floor 84 at the base of cabinet 80. This increased friction in combination with the tension force created by tensioner assembly 30 further deters the removal of the subject invention from between the underside of countertop 86 and floor 84 when a young child, such as an infant or toddler, attempts to open drawer or door 82 or attempts to pull pole 20 away from drawer or door 82.

To remove the installed invention from between floor 84 and underside of counter top 86, the user compresses tensioner assembly 30, by either applying a downward force to top surface 60 or by pulling pole 20 and bottom surface upward, and slides the subject invention out from between countertop 86 and floor 84.

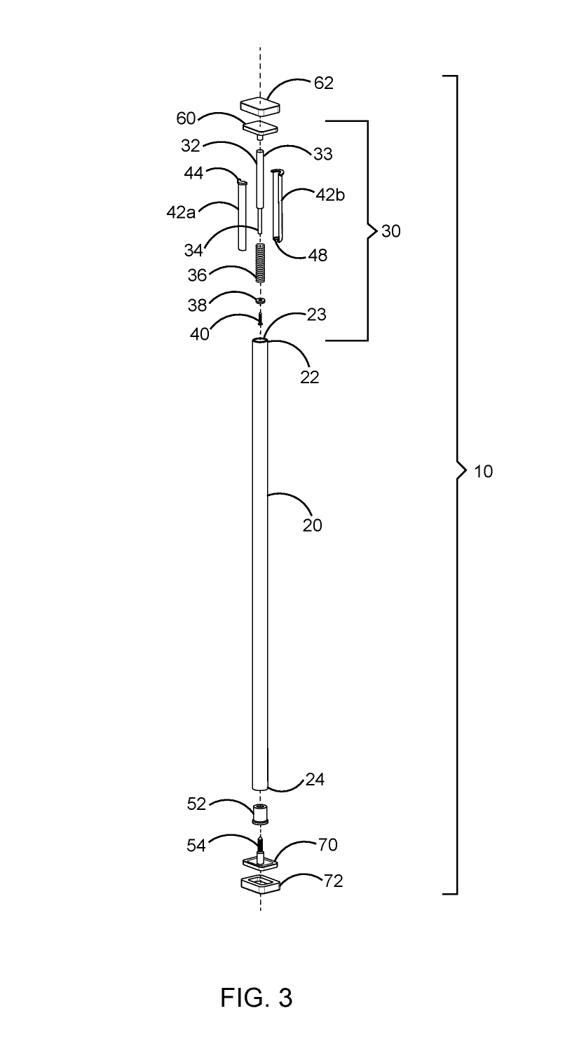

FIG. 3 depicts, in exploded view, a preferred embodiment of device 10 showing the details of tensioner assembly 30 and adjustable foot 50. In the preferred embodiment shown, pole 20 is a hollow cylinder with a bore 23. The proximal portion of tensioner 30 is inserted into bore 23.

Tensioner assembly 30 comprises a plunger 32, a spring 36, plunger end 38, a screw 40, a housing 42, and top surface 60. According to the embodiment illustrated in FIG. 3, the housing 42 is further comprised of left and right halves 42a and 42b that, when combined, form housing 42.

Housing 42 is a hollow cylinder that has an outside diameter smaller than bore 23 of pole 20. At the top or distal end of housing 42 is a lip 44 that protrudes outwardly. At the bottom or proximal end of housing 42 is a lip 48 that protrudes inwardly. The inside diameter of lip 48 is smaller than the diameter of spring 36.

Plunger 32 is cylindrical in shape comprising a first portion 33 and a second portion 34. First portion 33 has a diameter that is larger than the diameter of spring 36 but smaller than the diameter of housing 42. The diameter of second portion 34 is smaller than the inside diameter of spring 36 and smaller than the inside diameter of lip 48.

Plunger end 38 is an annulus with an inner diameter smaller than the outer diameter of spring 36 and an outer diameter larger than the inside diameter of lip 48.

When tensioner assembly 30 is fully assembled, second portion 34 of plunger 32 is inserted through the center of spring 36 and top of spring 36 is flush with the bottom of first portion 33 of plunger 32. Housing 42 encloses spring 36, second portion 34 of plunger 32, and a part of first portion 33 of plunger 32. The bottom of spring 36 is flush with top of lip 48. Lip 48 deters spring 36 from falling out of housing 42 because the inside diameter of lip 48 is smaller than the diameter of spring 36 but larger than the diameter of second portion 34. Plunger end 38 is adjacent to the underside of lip 48 and is secured to the bottom of plunger 32 by screw 40. The outside diameter of plunger end 38 is larger than the inside diameter of lip 48 and deters plunger 32 from being pulled out from the top end of housing 42. Top surface 60 is attached to top end of plunger 32.

To complete the assembly of tensioner assembly 30 into device 10, the bottom portion of tensioner assembly 30 is inserted into the bore 23 of pole 20 at top end 22 until the underside of lip 44 is flush with top end 22 of pole 20. The underside of lip 44 is attached to top end 22 of pole 20. Lip 44 deters tensioner assembly 30 from falling through the rod bore 23.

When the tensioner assembly 30 is engaged, plunger 32 is pushed further into housing 42. Because the inside diameter of lip 48 of housing 42 is smaller than the outside diameter of spring 36, but larger than the diameter of second portion 34 of plunger 32, lip 48 allows second portion 34 to pass through the bottom of housing 42 but keeps spring 36 contained within housing 42. As such, when plunger 32 is pushed further into housing 42, the bottom of first portion 33 of plunger 32 compresses spring 36 against the top of lip 48 and produces a tension force in the outward direction as spring 36 tries to return device 10 to its uncompressed state of rest.

In this preferred embodiment, top surface 60 is covered with a rubber cover 62, which increases the friction between top surface 60 and the underside of countertop lip 86 when device 10 is in use.

As depicted in FIG. 3, adjustable foot 50 comprises of an end cap 52 and a vertical lengthener 54. End cap 52 connects to bottom end 24 of pole 20. Bottom surface 70 is attached to end cap 52 by vertical lengthener 54. In this embodiment, lengthener 54 is a threaded screw-type lengthening means.

According to the preferred embodiment shown, the distance between top surface 60 and bottom surface 70 of device 10 can be lengthened or shortened through adjustable foot 50 by rotating bottom surface 70 relative to pole 20. Varying the overall length of device 10 in this manner can accommodate cabinets of different heights as well as vary the resulting amount of tension exhibited by device 10 when secured in position on a cabinet.

Also according to the embodiment shown in FIG. 3, bottom surface 70 is covered with a rubber cover 72, which increases the friction between bottom surface 70 and floor 84 when the device is in use.

It is anticipated that top surface 60 and bottom surface 70 could be both flat and curved. A curved top surface and bottom surface may help user install and remove the device from between the floor and underside of cabinet.

It is also anticipated that device 10 could be used upside-down such that top surface 60 engages with floor 84 and bottom surface 70 engages with countertop lip 86.

### SUMMARY AND SCOPE

As described above and illustrated in the accompanying figures, cabinet door and drawer retaining device 10 and the method of using device 10 is a simple, inexpensive and secure way to deter young children from accessing cabinets and cabinet contents. The device comprises a tension rod assembly that is compressed and slipped under the underside lip of cabinets having countertops that extend out away from the front surface of the cabinet. When in place, the tension created by the tension rod pressing upward against the underside of the countertop and downward against the floor is sufficient to secure the device in place and to deter young children from removing the device to access the contents of the cabinet.

While the device may be used only on cabinets that have countertops that extend out from the front of the cabinet, the countertop need only extend out an inch or two in order to be able to accommodate the device of the subject invention.

The device can have a vertically adjustable foot to adopt the device for use with cabinets of different heights and to increase or decrease the resting tension of the rod assembly when in place securing a cabinet. Non-skid surface material can be applied to the top and/or bottom surface of the device to make sliding the secured assembly more difficult.

The cabinet door and drawer retaining device of the instant invention can be used without alteration to cabinets or cabinet components and does not require any tools or special hardware to install or to use. It is easily portable so the device can be moved from cabinet to cabinet, and house or apartment to another house or apartment, with very little time or effort.

Unless otherwise indicated, all numbers, dimensions, materials and so forth used in the specification and claims are to be understood as being examples and not limitations, and in any event, not as an attempt to limit the application of the doctrine of equivalents to the scope of the claims.

The terms “a,” “an,” “the,” and similar references used in the context of describing the invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of any claim. No language in the specification should be construed as indicating any non-claimed element essential to the practice of the invention.

Certain embodiments are described herein, including the best mode known to the inventor for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein.

Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

By way of example, and not limitation, tensioner assembly 30 may be tensioned by means other than a spring, adjustable foot 50 may be made length adjustable to means other than a threaded screw extender, and non-skid materials other than those listed above may be employed, without departing from the scope or spirit of the invention. Device 10 may be employed with all variety of cabinets wherein the countertop lip extends out from the front surface of the cabinet to some degree, and the device made in the manner of two attached parallel devices in order to accommodate both doors of a two-door cabinet, or two sets of drawers of a side-by-side drawer chest, at the same time.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

I claim:

1. A tension rod assembly for securing doors and drawers of cabinets and chests that have countertop lips that extend out from the front surface thereof, comprising:
a length adjustable elongated body;
a top surface that engages the underside lip of the countertop;
a bottom surface that engages the floor directly below the underside lip of the countertop; and
a tensioning means.

2. The tension rod assembly of claim 1, wherein the tensioning means is spring loaded.

3. The tension rod assembly of claim 1, wherein said tensioning means is at least partially located within said elongated body.

4. The tension rod assembly of claim 1, wherein said tensioning means further comprises:
a plunger;
a spring;
a housing enclosing said spring and said plunger;
wherein said spring presses the plunger outward from said housing when said spring is compressed.

5. The tension rod assembly of claim 1, further comprising a length adjustable foot at the bottom of said elongated body.

6. The tension rod assembly of claim 5, wherein said foot is made length adjustable by means of a threaded screw assembly.

7. The tension rod assembly of claim 1, further comprising non-skid material applied to the top and/or bottom surface.

8. The tension rod assembly of claim 1,
wherein the elongated body is compressed to fit between the underside of countertop lip and the floor directly below the countertop lip;
and wherein the tensioning means serves to press said top surface against the underside of said countertop lip and press the bottom surface against the floor, rendering it difficult to remove said tension rod assembly from its engagement with said cabinet by pressing or sliding.

9. A system for securing doors and drawers of cabinets comprising:
a cabinet;
a lip that extends out from the top of said cabinet;
a length adjustable elongated body;
a top surface of said body that engages the underside lip of the countertop;
a bottom surface of said body that engages the floor directly below the underside lip of the countertop; and
a tensioning means.

10. The system of claim 9, wherein the tensioning means is spring loaded.

11. The system of claim 9, wherein said tensioning means is at least partially located within said elongated body.

12. The system of claim 9, further comprising a length adjustable foot at the bottom of the elongated body.

13. The system of claim 9, wherein said foot is made length adjustable by means of a threaded screw assembly.

14. The system of claim 9, further comprising non-skid material applied to the top and/or bottom surface.

15. The system of claim 9,
wherein the elongated body is compressed to fit between the underside of countertop lip and the floor directly below the countertop lip;
and wherein the tensioning means serves to press said top surface against the underside of said countertop lip and press the bottom surface against the floor, rendering it difficult to remove said tension rod assembly from its engagement with said cabinet by pressing or sliding.

16. A method of securing doors and drawers of cabinets and chests having countertops lips that extend out from the front surface thereof, comprising the steps of:
taking a tension rod assembly having a top surface that engages the underside lip of the countertop; a bottom surface that engages the floor directly below the underside lip of the countertop; and a tensioning means;
compressing the elongated body to fit between the underside of countertop lip and the floor directly below the countertop lip; and
releasing the elongated body such that the tensioning means presses the top surface against the underside of said countertop lip and the bottom surface against the floor, rendering it difficult to remove said tension rod assembly from its engagement with said cabinet by pressing or sliding.

17. The method of claim 16, wherein the tension rod assembly is removed from the cabinet by compressing the elongated body and removing the assembly from underneath the underside lip of the countertop.
